(19) United States
(12) Patent Application Publication
(10) Pub. No.: US 2003/0097371 A1
(43) Pub. Date: May 22, 2003

(54) Process basic record inquiry system

(76) Inventors: Kung-Cheng Tu, Kaohsiung (TW); Kun-Pei Li, Miaoli (TW); Ya-Ping Yeh, Tainan (TW)

Correspondence Address: POWELL, GOLDSTEIN, FRAZER & MURPHY LLP, P.O. BOX 97223, WASHINGTON, DC, 20090-7223, US

(21) Appl. No.: 09/989,115

(22) Filed: Nov. 21, 2001

(51) Int. Cl. G06F 7/00

(52) U.S. Cl. 707/104.1

(57) ABSTRACT

The present invention discloses a process basic record inquiry system, and the process basic record inquiry system comprises: a basic record inquiry server (BRI Server) and basic record inquiry clients (BRI Clients). While the process basic record system of the present invention is applied, the scattered and enormous data in a basic record system can be filtered and integrated properly, so that a completed manufacturing process is presented to users, and the database connection expense can be effectively saved.

### FIELD OF THE INVENTION

The present invention relates to a basic record inquiry system, and more particularly, to a process basic record inquiry system of manufacturing execution system (MES) utilized in wafer fabs.

### BACKGROUND OF THE INVENTION

A manufacturing execution system (MES) is a real-time online computer system integrating all kinds of related information in the production process, and the MES comprises the functions of: data collection; tracing of work in process (WIP); material management; management of goods in stock; exception management; and quality management, etc. Since the IC production is featured in: complicated manufacturing steps; expensive processing equipments; numerous product varieties; and short product life, IC manufacturers strongly need a MES for managing a production site so as to meet the ever-changing requirements from clients and to face the competition and challenge of e-generation. A MES can help IC manufacturers to collect on-site data, and to convert the data into useful information for controlling and managing the production site, thereby reaching the goals of automatic management and maximum efficiency for factories. A commercialized Poseidom System is commonly provided to use.

Referring to FIG. 1, FIG. 1 depicts a structural diagram of known Poseidon System 10 which comprising subsystems of: a floor control 100; a basic record (BR) 110; a scheduling and bank control 120; a tool control system (TCS) 130; a central monitor 140; a report system 150; a transfer system 160; a statistical process control (SPC) 170; an engineering data analysis (EDA) 180; and an external interface 190, wherein the transfer system 160 further comprises a reticle stocker 162, an interbay transfer system 164 and an intrabay automated guided vehicle system 166, and furthermore, the external interface comprises a corporation information system (CIS) 192.

Just as described above, BR is one of the Poseidon subsystems for defining some basic records, such as the wafer processing path, the processing machines used, the material amount consumed, and the processing pressure, etc., during the production process. Referring to FIG. 2, FIG. 2 depicts an operational flow chart for a basic record subsystem, wherein a database server 200 has a work file 210. Step 211 is performed in a basic record client computer 220 which is connected to the database server 200 for executing the function of file transfer protocol (FTP) and obtaining the work file 210. Thereafter, step 212 is preformed for saving a new work file 230, then connecting again to the database server 200 from the basic record client computer 220 for executing the function of FTP, and the new work file 230 can be transmitted back to the database server 200. Following, step 213 is performed in a basic record client computer 220 for checking file consistence in data by utilizing the new work file 230 and other data sheets of the database server 200 (not shown). If it is determined that data is inconsistent, the database server 200 generated an error report (not shown), which is downloaded in and displayed on the basic record client computer 220 by connecting to the database server 200 for executing the function of FTP. If it is determined that data is consistent, the check-flag turns to “Y”, and subsequent uploading data is allowed by the system. And then in the step 214, the database server 200 generates an updated file 240 by utilizing the data in the new work file 230 and the database server 200. The nodes of an area control (AC) database 250, an EDA server, or an sub area server (SAC) etc., can be connected to database server 200 for executing the function of FTP and downloading the updated file 240, thereby updating the data in each node by utilizing the updated file 240.

The aforementioned BR subsystem of Poseidon does not have a completed inquiry system for users to understand the settings of BR subsystem with the required parameters and screens, and is very inconvenient for the users. Hence, it is necessary to seek a way to resolve this issue.

### SUMMARY OF THE INVENTION

In consideration of the shortcomings of known Poseidon system mentioned in the aforementioned background of the invention, an object of the present invention is to provide a process basic record inquiry system for filtering and integrating the scattered and enormous data in BR, thereby showing a completed manufacturing process to users.

Another object of the present invention is to provide a process basic record inquiry system, and the basic record inquiry system is a three-tier structure having only one connection to the database, thereby effectively saving the database connection expense.

Another object of the present invention is to provide a process basic record inquiry system, so that users can change an inquiry program only by modifying a data module in a basic record inquiry server (BRI Server). Unless the formats of output reports are changed, the users do not have to modify any basic record inquiry client computer.

In accordance with the aforementioned objects, the present invention provides a process basic record inquiry system connecting to an area controller database (AC Database). The process basic record inquiry system comprises: a basic record inquiry server (BRI Server) which has a plurality of data modules, and is connected to the AC Database; and a plurality of basic record inquiry clients (BRI Clients) connected to the BRI Server, wherein each of the BRI Client has a plurality of input tables and output reports, and these input tables are used for generating in these output reports by entering at least one inquiry item.

### BRIEF DESCRIPTION OF THE DRAWINGS

The foregoing aspects and many of the attendant advantages of this invention will become more readily appreciated as the same becomes better understood by reference to the following detailed description, when taken in conjunction with the the accompanying drawings, wherein:

FIG. 1 depicts a structural diagram of known Poseidon System;

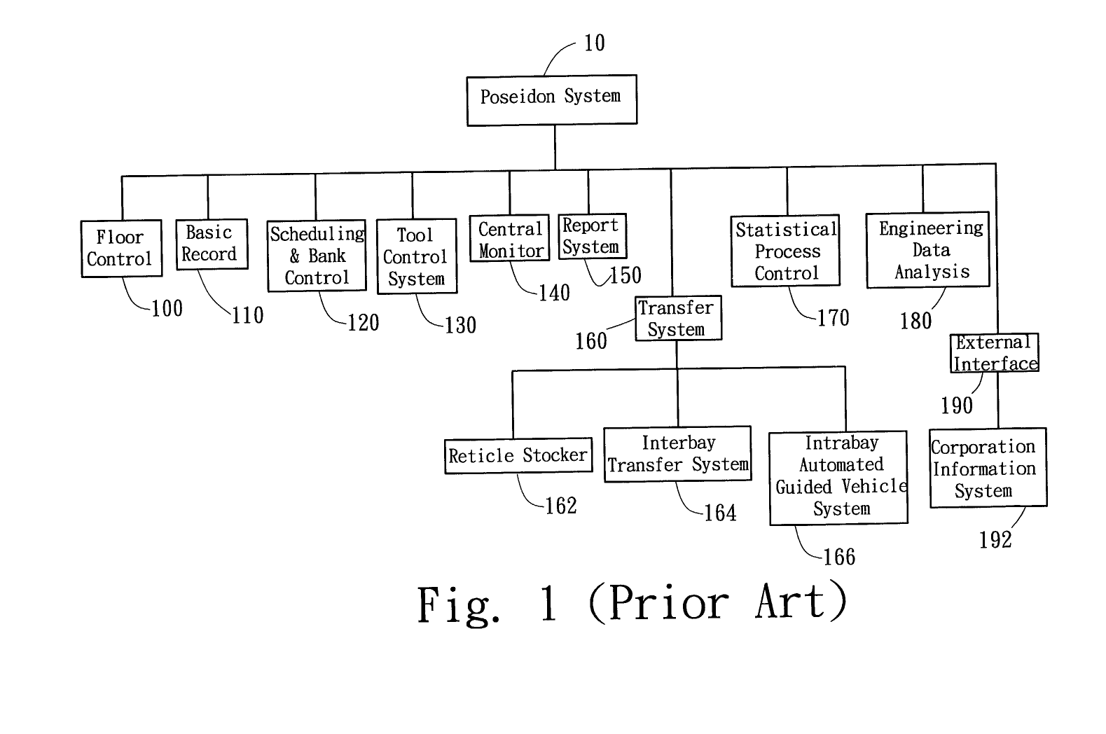

FIG. 2 depicts an operational flow chart for a known basic record subsystem of Poseidon System;

FIG. 3 depicts a structural diagram of a process basic record inquiry system of Poseidon System according to a preferred embodiment of the present invention;

FIG. 4 depicts a preferred embodiment of the present invention in a basic record inquiry server, in which there is a classified diagram for classifying data modules and inquiry program in detail; and

Table 1 is illustrated for a preferred embodiment of the present invention, wherein data in the input column of input table are provided by inquiry program BRI1010, and data in the output column of output report are resulted via searching.

### DETAILED DESCRIPTION OF THE PREFERRED EMBODIMENT

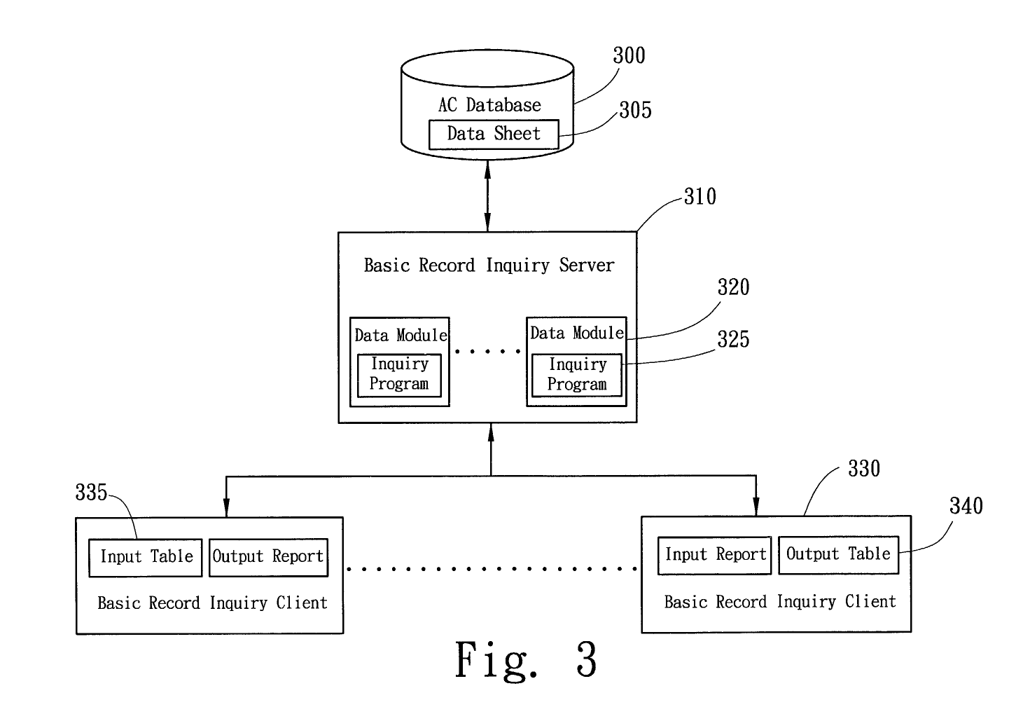

The present invention relates a process basic record inquiry system, and the process basic record inquiry system is a three-tier structure. Referring to FIG. 3, objects in the intermediate tier within the three-tier structure can participate in various application programs, and can be shared by every application program. The objects in the lowest tier only communicate with those in the intermediate tier, and do not directly talk to the database on the upmost tier, so that the upmost tier and the lowest tier are independent thereby enhancing the system flexibility and expandability. In other words, there is only one connection to the database of the upmost tier within the three-tier structure unlike common client-server structures having several connections to the database. The three-tier structure has the following advantages. First, various objects in the upmost tier do not affect the application programs in the lowest tier. For example, to execute the application programs in the lowest tier do not have to consider what database is used in the upmost tier. Secondly, the application programs in the lowest tier do not receive any impact from the complicated network devices in the upmost tier. Thirdly, the shortcomings of inconsistency, lacking reusability and flexibility, etc., due to the two-tier structure overly emphasizing the client or the server, are prevented.

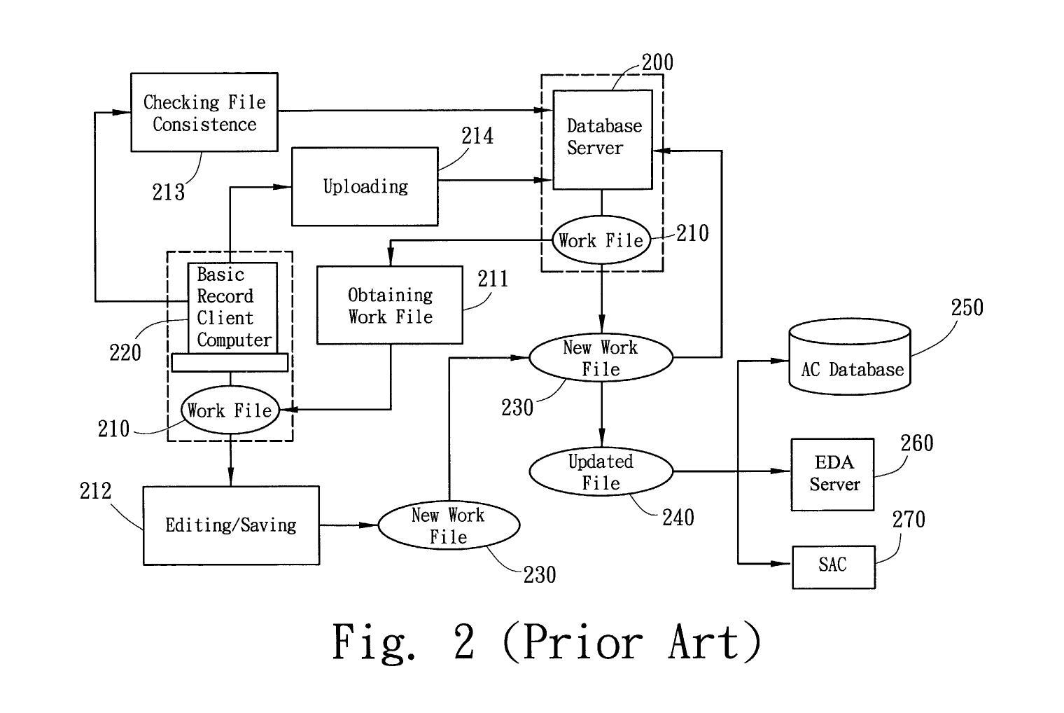

Please referring to FIG. 3, FIG. 3 is a structural diagram depicting a process basic record inquiry system of Poseidon system in accordance with a preferred embodiment of the present invention, wherein the upmost tier is an AC database 300 (i.e. the AC database 250 shown in FIG. 2) having a data sheet 305 generated by the BR subsystem of known Poseidon system; and the intermediate tier is a BRI Server 310 having a plurality of data modules 320, wherein the BRI Server 310 is connected to the AC database 300; and the lowest tier comprises a plurality of BRI Clients 330 connected to the BRI Server 310, wherein users can enter inquiry items into the input tables 335 of BRI Client 330 resulting in the output reports 340 of various patterns and screens in accordance with the user requests, and wherein the output reports 340 are fabricated with, for example, Access software.

Each aforementioned output report 340 in the BRI Server 310 has corresponded to a data module 320 in which an inquiry program 325 are stored, and the inquiry program 325 can be coded with, for example, a structural query language (SQL). For changing the inquiry program, users only need to modify the data module 320 in the BRI Server 310. Unless the formats of reports 340 are changed, users do not have to modify every BRI Client 330.

Besides, in a preferred embodiment of the present invention, output reports 340 are fabricated with Access software, and can be easily converted to Excel or HTML format, etc., so that users can apply the reports conveniently.

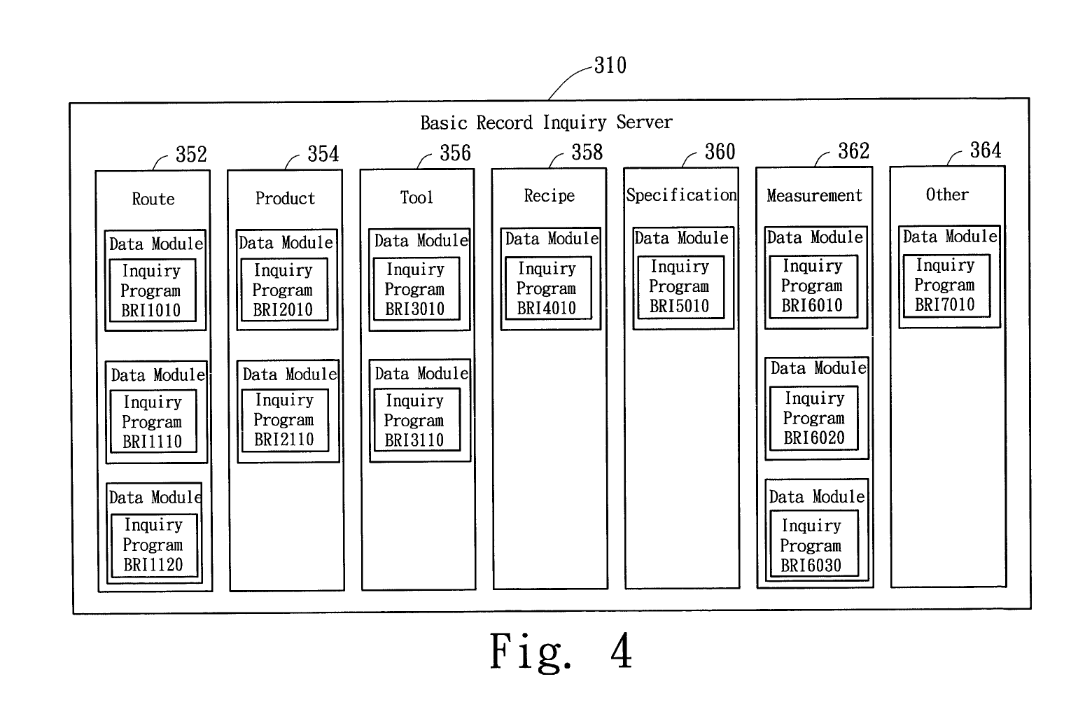

Referring FIG. 4, FIG. 4 depicts a preferred embodiment of the present invention in BRI server, in which there is a diagram for classifying data modules and inquiry programs in detail. Data modules and inquiry programs in BRI server 310 illustrated in FIG. 4, are classified into 7 categories and 13 inquiry programs. The 7 categories are route 352, product 354, tool 356, recipe 358, specification 360, measurement 362, and other 364, respectively. Each inquiry program is named according to the actual condition, such as BRI1010. The names of 13 inquiry programs shown in FIG. 4 are just those in a preferred embodiment of the present invention. Table 1 shown below is illustrated as an example for a preferred embodiment of the present invention, wherein data in the input column of input table are provided by inquiry program BR1010, and data in the output column of output report are resulted via searching.

Tab. 1 Data in the input column of input table are provided
by Inquiry Program BRI1010, and data in the output column of
output report are resulted via searching

| Input Column | Output Column |
|---|---|
| Main Route | Route |
| Product | Operation |
| Department | Operation Description |
| Operation | Measurement ID |
| | Working Area |
| | Tool Group |
| | Tool ID |
| | Recipe ID |
| | Measurement Item Count |
| | Specification Check Item Name |
| | Lower Hold Specification Limit |
| | Upper Hold Specification Limit |
| | Q Restriction Time |
| | Q Restriction Target Operation |
| | Connection Route ID |
| | Input Operation |

To summarize the above, the main advantage of the present invention is to provide a process basic record inquiry system, which is applied to filter and integrate the scattered and enormous data in the basic record, thereby presenting a completed manufacturing process to users.

Another advantage of the present invention is that the basic record inquiry system is a three-tier structure with only one connection to database. The application of the basic record inquiry system of the present invention can effectively save the database connection expense.

A further advantage of the present invention is that only the data modules in the BRI server need to be modified while the inquiry programs need changing. Unless the formats of reports are changed, users do not have to modify every single BRI Client.

As is understood by a person skilled in the art, the foregoing preferred embodiments of the present invention are illustrated of the present invention rather than limiting the scope of the present invention. It is intended to cover various modifications and similar arrangements included within the spirit and scope of the appended claims, the scope of which should be accorded the broadest interpretation so as to encompass all such modifications and similar structure.

What is claimed is:

1. A process basic record inquiry system, wherein the basic record inquiry system connects to an area controller database (AC Database), and the process basic record inquiry system comprises:
a basic record inquiry server (BRI Server), wherein the BRI Server has a plurality of data modules, and the BRI Server is connected to the AC Database; and
a plurality of basic record inquiry clients (BRI Clients) connected to the BRI Server, and each of the BRI Client has a plurality of input tables and output reports, wherein these input tables are used for generating in these output reports by entering at least one inquiry item.

2. The process basic record inquiry system of claim 1, wherein each of the data modules comprises an inquiry program.

3. The process basic record inquiry system of claim 2, wherein the inquiry program is coded with a structural query language (SQL).

4. The process basic record inquiry system of claim 1, wherein the output reports are fabricated with Access software.

5. A process basic record inquiry system, wherein the basic record inquiry system connects to an area controller database, and the process basic record inquiry system comprises:
an inquiry server, wherein the inquiry server has a plurality of data modules, and the inquiry server is connected to the AC database; and
a plurality of client computers, wherein each of the client computers has a plurality of input tables and output reports, wherein these input tables are used for generating in the output reports by entering at least one inquiry item.

6. The process basic record inquiry system of claim 5, wherein each of the data module comprises an inquiry program.

7. The process basic record inquiry system of claim 6, wherein the inquiry program is coded with a SQL.

8. The process basic record system of claim 5, wherein the output reports are fabricated with Access software.
